(19) United States
(12) Patent Application Publication
(10) Pub. No.: US 2019/0156701 A1
(43) Pub. Date: May 23, 2019

(54) CONVERSION OF A VISUAL COMMUNICATION TOOL TO TACTILE COMMUNICATION TOOL

(71) Applicant: KIMBERLY WHITE, LIVONIA, MI (US)

(72) Inventor: KIMBERLY WHITE, LIVONIA, MI (US)

(21) Appl. No.: 15/816,415

(22) Filed: Nov. 17, 2017

(51) Int. Cl. G09B 21/00

(52) U.S. Cl. CPC G09B 21/003

(57) ABSTRACT

An adapter set for converting a visual communication tool to a tactile communication tool is provided. The visual communication tool presents a user with a plurality of actuatable visual cues to be actuated by a user thereby causing rendering of a word or phrase. The adapter set includes a plurality of tactile overlays. Each tactile overlay is positionable over and securable to a corresponding actuatable visual cue where the tactile overlay has a tactile pattern that represents the corresponding visual cue. Characteristically, the tactile pattern being recognizable by touch.

### TECHNICAL FIELD

In at least one aspect, the present invention is related to audio learning or communication tools, and in particular, to tactile learning or communication tools.

### BACKGROUND

Augmentative and alternative communication techniques are currently used to assist individuals with various language impairments. Such impairments may be congenital such as cerebral palsy or can be the result of disease such as Parkinson's disease. Mayer-Johnson has developed a set of picture communication symbols (“PCS”) to be used in various systems to assist a user in verbal communication. Examples of such systems include the GoTalk product line such as the GoTalk 20+. These systems are tablet devices that present a user with a set of drawings over buttons that can be actuated to produce a word or phrase. Although these devices work very well for many impaired users, specific needs for visually impaired user can be better addressed.

Accordingly, there is a need for improved communication tools designs for visually impaired users.

### SUMMARY

The present invention solves one or more problems of the prior art by providing in at least on embodiment, an adapter set for converting a visual communication tool to a tactile communication tool. The visual communication tool presents a user with a plurality of actuatable visual cues to be actuated by a user thereby causing rendering of a word or phrase. The adapter set includes a plurality of tactile overlays. Each tactile overlay is positionable over and securable to a corresponding actuatable visual cue where the tactile overlay has a tactile pattern that represents the corresponding visual cue. Characteristically, the tactile pattern being recognizable by touch.

### BRIEF DESCRIPTION OF THE DRAWINGS

FIG. 1 is a schematic illustration of a visual communications tool that can be converted to a tactile communication tool by various embodiments of the present invention;

FIG. 2 is a schematic of the active components of the visual communications tool depicted in FIG. 1;

FIG. 3 is a schematic illustration showing the placement of visual icons/drawings within a visual communication tool;

FIG. 4A is a top view of a tactile overlay;

FIG. 4B is a perspective view of a tactile overlay;

FIG. 5A is a top view of a tactile overlay having attachment features;

FIG. 5B is a perspective view of a tactile overlay having attachment features;

FIG. 6 is a schematic showing the placement of tactile overlays in a visual communication device.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

It must also be noted that, as used in the specification and the appended claims, the singular form “a,” “an,” and “the” comprise plural referents unless the context clearly indicates otherwise. For example, reference to a component in the singular is intended to comprise a plurality of components.

The term “comprising” is synonymous with “including,” “having,” “containing,” or “characterized by.” These terms are inclusive and open-ended and do not exclude additional, unrecited elements or method steps.

The phrase “consisting of” excludes any element, step, or ingredient not specified in the claim. When this phrase appears in a clause of the body of a claim, rather than immediately following the preamble, it limits only the element set forth in that clause; other elements are not excluded from the claim as a whole.

The phrase “consisting essentially of” limits the scope of a claim to the specified materials or steps, plus those that do not materially affect the basic and novel characteristic(s) of the claimed subject matter.

With respect to the terms “comprising,” “consisting of,” and “consisting essentially of,” where one of these three terms is used herein, the presently disclosed and claimed subject matter can include the use of either of the other two terms.

Throughout this application, where publications are referenced, the disclosures of these publications in their entireties are hereby incorporated by reference into this application to more fully describe the state of the art to which this invention pertains.

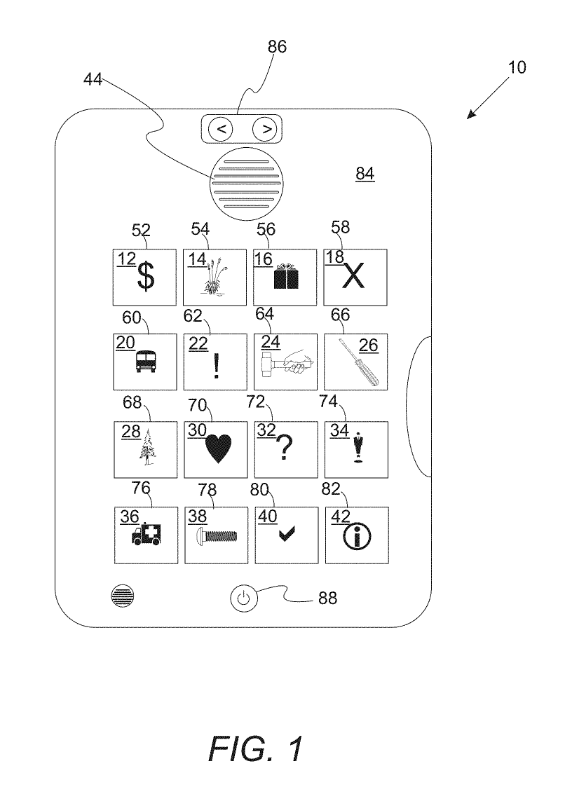

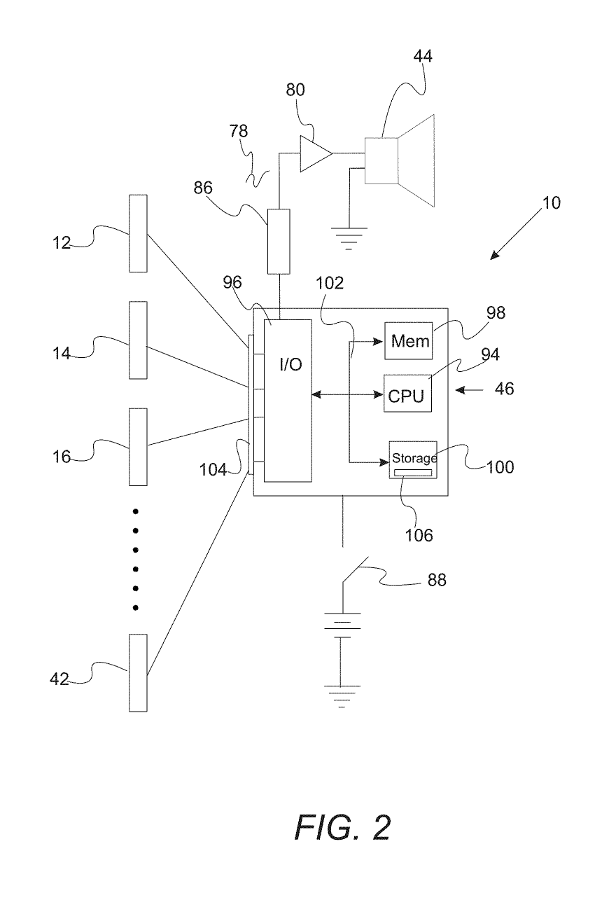

With reference to FIGS. 1 and 2, schematic illustrations of a visual picture learning or communication tool are provided. Visual communication tool 10 includes a plurality of actuatable visual cues 12-42 that when actuated by a user say a word or phrase associated with the actuatable visual cue. Embodiments of the present invention provide adapters for converging visual cues into tactile cues. In this regard, visual communication tool includes speaker 44 which is in communication with voice generator 46 which is in turn in communication with actuatable visual cues 12-42. Typically, each of actuatable visual cues 12-42 is a button that displays a drawing on its visible surface. The visible surface of actuatable visual cues 12-42 is exposed through openings 52-82 defined by side 84 of visual communication tool 10. Typically, side 84 will have a thickness from about 1 to 5 mm and can be formed from plastic. Typically, these drawings are related to the word or phrase pronounced when the associated button is actuated. Visual communication tool 10 also includes volume control 86 and on/off button 88.

With reference to FIG. 2, voice generator 46 receive a user selection regarding which button has been actuated. Typically, voice generator 46 is a microprocessor system that includes central processing unit 94 that communicates with input/output subsystem 96, random access memory 98, and memory storage device 100 along one or more buses 102. Voice generator 46 includes an input interface 104 which is in electrical communication with actuatable visual cues 12-42. The input from actuatable visual cues 12-14 is ultimately received by input/output subsystem 96 of voice generator 46. The button selection is interpreted by CPU 94. An appropriate sound file 106 is retrieved from memory storage device 100. The sound file is processed by CPU 94 with an output signal 78 being provide to speaker 50 through input/output subsystem 96. This signal can be applied by amplifier 80 before reaching speaker 50.

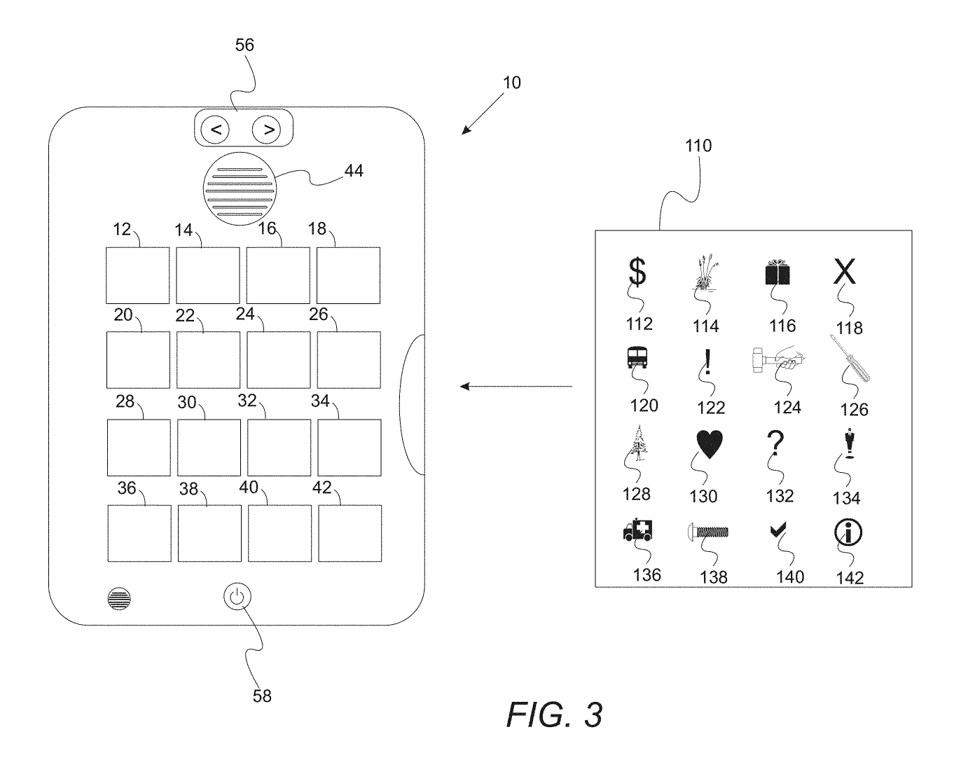

With reference to FIG. 3, is a schematic illustration showing the placement of visual icons/drawings within visual communication tool 10 is provided. Sheet 110 includes a plurality of visual icons/drawings 112-142 that correspond to actuatable visual cues 12-42. Sheet 110 is passed through slit 150 such that icons/drawings 112-142 align with openings 52-82 corresponding to actuatable visual cues 12-42

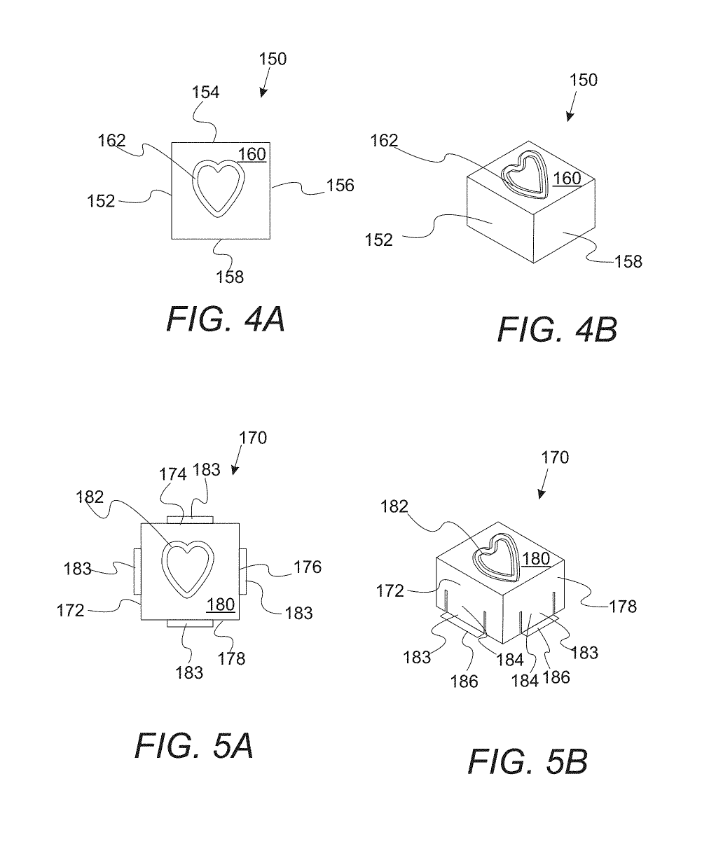

With reference to FIGS. 4A, 4B, 5A, and 5B, schematic illustrations of a tactile overlay are provided. The tactile overlays 150 and 170 are sized to fit in openings 52-82. In particular, tactile overlay 150 is sized to fit snuggly in openings 52-82. Tactile overlay 150 includes a base section formed by side walls 152, 154, 156, 158 and a displayer section 160. Display section 160 is a top wall that has tactile pattern 162 embossed thereon. Characteristically, tactile pattern 162 is discernible by a user's touch. Tactile overlay 170 includes a base section formed by side walls 172, 174, 176, 178 and a display section 180. Display section 180 is a top wall that has tactile pattern 182 embossed thereon. Tactile overlay 170 also includes at least a pair of attachment features 183 that assist in holding tactile overly 170 in openings 52-82. FIGS. 5A and 5B illustrate an attachment feature that has a tab section 184 and a protruding section 186 extending from the tab section typically at a distal end of the tab section (i.e., the end most distant from top wall 180). In this refinement, the distal end can move relative to its respective sidewall thereby providing a force that act to retain the overlay when it is positioned in openings 52-82 with the protruding section contacting a sidewall of the opening. The tactile overlays can be made of any suitable material such as plastic, metal, rubber and the like.

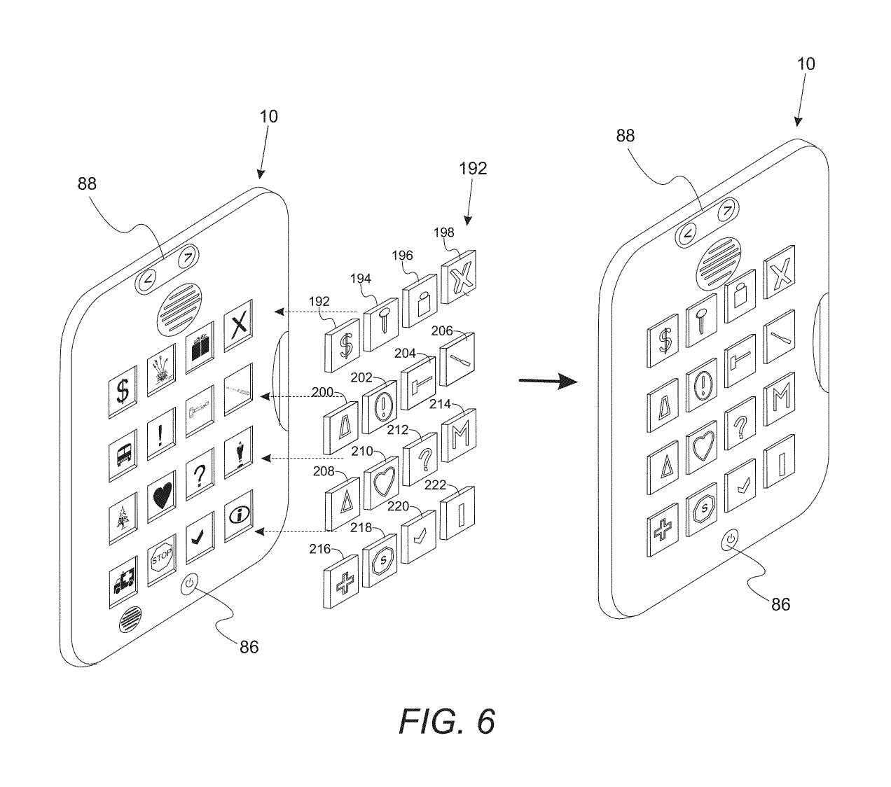

With reference to FIG. 6, an adapter set for converting a visual communication tool to a tactile communication tool is provided. Adapter set 190 includes a plurality of tactile overlays 192-222 to be attached to visual communication tool 10. Tactile overlays 192-222 can be of the design set forth in FIGS. 4A, 4B, 5A, and 5B. As set forth above, visual communication tool 10 presents a user with a plurality of actuatable visual cues to be actuated by a user thereby rendering a word or phrase associated with the actuated visual cue. Each tactile overlay is positionable over and securable to a corresponding visual cue where the tactile overlay has a tactile pattern that represents the corresponding visual cue as set forth in FIGS. 4A, 4B, 5A, and 5B. Characteristically, the tactile pattern being recognizable by the user. Typically, the tactile overlays are sufficiently moveable when attached to a corresponding visual cue to actuate the corresponding visual cue.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. An adapter set for converting a visual communication tool to a tactile communication tool, the visual communication tool presenting a user with a plurality of actuatable visual cues to be actuated by a user thereby causing rendering of a word or phrase, the adapter set comprising:
a plurality of tactile overlays, each tactile overlay positionable over and securable to a corresponding actuatable visual cue where the tactile overlay has a tactile pattern that represents the corresponding visual cue, the tactile pattern being recognizable by touch.

2. The adapter set of claim 1 wherein each actuatable visual cue includes a drawing positioned over a button.

3. The adapter set of claim 1 where each tactile overlay has a display section defining the tactile pattern and a base section attached to the display section, the base section having at least a pair attachment features for attaching the tactile overlay to a corresponding visual cue.

4. The adapter set of claim 3 wherein tactile pattern is embossed on the display section.

5. The adapter set of claim 1 wherein the tactile overlays comprise a plastic.

6. The adapter set of claim 1 wherein the tactile overlays are sufficiently moveable when attached to a corresponding visual cue to actuate the corresponding visual cue.

7. The adapter set of claim 1 wherein the visual communication tool defines opening that expose the actuatable visual cues, each tactile overlay being positioned in the openings.

8. The adapter set of claim 7 wherein each tactile overlay includes at least a pair of attachment features that assist in holding the tactile overly in the openings.
